(19) United States
(12) Patent Application Publication
(10) Pub. No.: US 2024/0146012 A1
(43) Pub. Date: May 2, 2024

(54) INTRACAVITY HOLOGRAPHIC LASER MODE CONVERTER

(71) Applicant: IPG PHOTONICS CORPORATION, MARLBOROUGH, MA (US)

(72) Inventors: Ivan DIVLIANSKY, Oxford, MA (US); Leonid GLEBOV, Oxford, MA (US); Lam MACH, Oxford, MA (US); Oussama MHIBIK, Oxford, MA (US); Nafiseh MOHAMMADDIAN, Oxford, MA (US)

(73) Assignee: IPG PHOTONICS CORPORATION, MARLBOROUGH, MA (US)

(21) Appl. No.: 18/279,647

(22) PCT Filed: Mar. 7, 2022
(86) PCT No.: PCT/US2022/019088

§ 371 Date: Sep. 5, 2023

Related U.S. Application Data
(60) Provisional application No. 63/157,536, filed on Mar. 5, 2021.

(51) Int. Cl. H01S 3/08045; H01S 3/08; H01S 3/081; H01S 3/16

(52) U.S. Cl. CPC H01S 3/08045; H01S 3/08009; H01S 3/08072; H01S 3/0815; H01S 3/1618

(57) ABSTRACT

This invention is a broadband intra cavity laser mode convertor. This is a hologram of a complex phase mask imprinted inside of a volume Bragg grating with wide spectral width recorded in photo-thermo-refractive (PTR) glass. This hologram is a broadband phase converting monolithic device capable of use over a broad wavelength range at high instant and average power because of low absorption coefficient and low nonlinear refractive index of PTR glass. Therefore, it can be used for broadband optical beam transformations and conversion of modes in laser resonators.

### BACKGROUND OF THE DISCLOSURE

### Field of the Disclosure

The present disclosure relates to phase beam transformation methods. In particular, the disclosure relates to a laser provided with an intracavity achromatic holographic phase mask which is configured to provide spatial transverse mode conversion.

### Prior Art Discussion

The transverse mode transformation methods are used to provide mode conversion between, for example, a Gaussian lateral profile of intensity and plane wavefront into other, more complex mode profiles that are required by various laser applications. These converted modes may include, without limitation, TEMₘₙ, Lager-Gaussian LGₙₘ, Airy, Bessel and others. The mode shaping techniques include amplitude modulation, phase modulation, or a combination of both and can be carried out outside a laser cavity or inside thereof, the latter being most relevant here.

The mode's phase profile transformation methods include phase correction applied to localized areas of the mode wavefront. As a result, the beam propagation characteristics can be altered to provide the desired irradiance profile in the far field of the shaped mode. The phase retardation enabling the desired mode shape transformation is determined by optical path difference measured in fractions of a wavelength. The optical path difference is the product of the thickness of the medium, through which a beam travels, and the medium's refractive index. The elements controlling the phase profile include phase masks, which are of particular interest here, diffractive optical elements (DOEs), and spatial light modulators (SLMs). Because a particular phase shifting action can only be realized for a specific wavelength, all phase shaping elements show a high degree of chromatism—the phenomenon characterizing narrowband and relatively low power modes. Yet the modes with a high power and broad spectral line are indispensable for a great variety of laser industrial applications.

The phase mask is an optical element where optical paths of a transmitted mode have a specified distribution across the aperture and, as the term, is used to define any optical element excluding traditional lenses in which a spatially dependent phase profile is induced. Known are two methods for producing a permanent phase mask with the predetermined phase distribution. The first method includes fabricating profiled surfaces of an optically transparent uniform material—surface phase masks. This method can be carried out by different techniques of selective etching or deposition. These method produces desirable profiles of geometrical thickness and, correspondingly, profiles of optical phase in transmitted beams. The second method includes changing the material's local refractive index in the volume of the medium across the aperture of the beam. These changes produce the desirable profile of the optical path and, as a consequence, optical phase in a transmitted mode. The materials suitable for fabricating VBGs are photosensitive.

An example of photosensitive materials is a photo-thermo-refractive (PTR) glass that provides a change of refractive index after the material's exposure to UV radiation followed by a thermal development. This sequence results in a permanent material refractive index change, which cannot be bleached by laser radiation, and its low absorption in visible and near IR spectral regions. These features enable the fabrication of VBGs characterized by high efficiency and high tolerance to laser radiation, mechanical shocks and elevated temperatures. In particular, VBGs are produced by exposure of a homogeneous PTR glass plate to an interference pattern of two collimated UV beams converging at some angle. For these conditions, the interference pattern is a system of plane-parallel fringes. A converging angle determines a period of the interference pattern. After thermal development, a system of plane-parallel layers with modified refractive index is produced in the volume of PTR glass. A distance between layers is equal to a period of the interference pattern. Diffraction of light at the VBG complies with the Bragg law:

$$sin θ = \frac{λ}{2 nd}$$

where λ is wavelength, n is average refractive index of a photosensitive medium, d is the distance between layers with uniform refractive index, and θ is an angle between direction of beam propagation and planes of uniform refractive index. This formula shows that while VBGs are narrowband devices with narrow spectral and angular acceptance, an important feature of conventional VBGs is tunability. Changing the incident angle leads to tuning the VBG to different resonant wavelengths.

The volume Bragg masks (VPM) are made by exposing a PTR glass plate to UV radiation through an amplitude mask which is produced my means of conventional or probabilistic photolithography. This technology enables fabrication of complex phase masks (PM) within glass plates which have respective flat polished surfaces that provide high resistance to the laser radiation and surface contamination of optics.

The narrowband limitation has been fairly recently overcome by a fairly new development of holographic volume phase masks (HPM). The HPM is an optical element produced by incorporation of volume phase mask in the VBG. This method produces desirable profiles in a beam diffracted by the VBG. In particular, the HPM is produced by embedding the desired phase information onto a transmissive VBG, and holographically recording it into a thick medium of PTR glass. As a result, the HPM operates such that the phase profile of the diffracted mode is the same as the phase profile of the recording UV beam, which is used during the fabrication of the HPM, regardless of the diffracted wavelength. In use, the thus fabricated HPM embeds its own phase profile on the diffracted mode. This is in contrast to a conventional VBG which, when in use, diffracts the mode with the phase profile of the incident beam. This means that contrary to a conventional surface or volume PM, the HPM is a tunable device within a transparency window of photosensitive medium. For PTR glass, this window is from 350 to 2700 nm. Demonstration of converting a Gaussian mode to different spatial modes and vice versa was produced by angular tuning of the HPM.

The beam shaping capabilities of HPM have been exploited in the optical configuration including the HPM in combination with two surface gratings. This configuration enables an achromatic mode conversion for broadband or multiwavelength beams, such as femtosecond (fs) beams, in at least a 300 nm frequency range. Furthermore, multiple HPMs can be recorded in the same PTR volume which allows multiplication of several broadband beams propagating at respective different wavelengths and in different spatial modes. Thus HPMs are capable of providing spatial conversion and spatial combining of multiple broadband laser beams.

A further development of the HPM technology is disclosed in U.S. Patent Application No. 62/970,001. The latter teaches a method of HPM recording in a PTR volume when parameters of recording UV beams provide broad spectral acceptance. It was found that within this spectral acceptance phase incursion for any spectral component is identical. Thus, the HPM produced by the disclosed method is monolithic and achromatic and does not require surface gratings.

The above disclosed HPMs has been used in the context of laser beams propagating in free space externally to the laser cavity which is rather the typical method of laser mode shaping in order to obtain the desired spatial distribution and propagation characteristics of the mode. Yet, shaping a laser mode within the resonator ensures that the gain is coupled preferentially into the prescribed spatial mode distribution thus minimizing losses.

Accordingly, what is needed is a broadband laser provided with an intracavity HPM which operates within a broadband laser resonator to provide mode conversion between variously shaped modes.

### SUMMARY OF THE DISCLOSURE

This need is met by the disclosed laser configurations incorporating a HPM which is an achromatic and tunable diffraction element capable of transverse mode-shaping of broadband beams. Several inventive aspects and their respective features are disclosed below and intertwined conceptually and structurally so that each of the below disclosed specific features can be combined with one or multiple other features.

In accordance a base feature of the disclosure, a resonator, configured to generate a radiation in a predetermined transverse mode, includes an HPM which is tuned to a Bragg angle to diffract a portion of the predetermined transverse mode. While diffracting, the HPM encodes its phase profile on a diffracted transverse mode which is different from that of the predetermined mode. As a consequence, the HPM operates as an output coupler guiding the diffracted transverse mode with a spectral width, which is at most equal to that of the HPM, outside the resonator.

The broadband resonator is configured to support a fundamental mode with the Gaussian phase profile. Typically, laser sources and their pumping schemes provide the spatial profile of most coherent optical beams with the Gaussian phase profile. Accordingly the HPM is configured to provide the conversion of the Gaussian mode to complex TEMₘₙ, Lager-Gaussian LGₙₘ, Airy, Bessel and other complex mode shape and back to the Gaussian mode if needed.

However, the disclosed resonator is not limited to supporting only the Gaussian mode and can be configured to support multiple high order modes. Such lasers are referred to as multimode (MM) lasers. Accordingly, in a further development of this aspect, the HPM is configured with a spectral width of up to at least 300 nm to provide phase conversion between non-Gaussian or complex modes.

In accordance with another feature, the broadband resonator is plain and defined between two spaced reflectors. The resonator further includes a gain medium which can be selected from a variety of materials providing amplification of the predetermined mode at the desired wavelength. A variety of gain media is too great to be listed here, but in general crystal grown YAGs doped with various rare earth ions such as ytterbium, Yb:KGW, Yb:KYW and other crystals used for generation of pulses, which include sub-nanosecond high power pulses, have been successfully tested within the context of this disclosure.

In a further feature, the disclosed reflectors are configured as respective plain high reflection mirrors (HRs) defining the resonant cavity therebetween and preserving all the energy, which is generated within the resonator, inside thereof. The cavity's architecture provides the shape of the predetermined transverse mode travelling between the HRs along the resonator's axis. Spaced from the HRs inside the resonator, the HPM is mounted so that the HPM functions as a bidirectional output coupler providing two outputs in a diffraction plane which is transverse to the axial plane of the resonator. In other words, the output direction of each of the two diffracted transverse modes is specific to the axial direction of propagation of the predetermined mode. Thus, the HPM mode converter is configured so that the predetermined transverse modes stay within the resonator while the diffracted transverse modes, having the phase profiles of the HPM, are decoupled from the resonator.

Still another structural feature includes an additional HR mirror mounted in the diffracted plane along one of the opposite directions of the diffracted transverse mode. This feature allows the intended target of the resonator's output to receive a substantially higher output power than in the architecture with two outputs of the diffracted transverse mode.

A further structural modification of the above discussed features stems from the fact that the diffracted transverse mode reflected from the additional HR mirror may have a phase incursion different from that of the diffracted transverse mode propagating in the opposite diffraction direction. As a result, the diffracted transverse modes may destructively interfere with one another attenuating the output signal. To prevent it, the additional HR mirror is displaceable in the diffraction plane thus altering the path of the reflected diffracted transverse mode to adjust the interference pattern.

In accordance with still another feature, the HPM does not function as an output coupler but only as an intracavity mode converter. The resonator's configuration includes end reflectors defining the cavity with only one of the end reflectors being a HR mirror. The other, output mirror (PR) only partially reflects incident light. The HPM is configured with a high conversion efficiency and mounted so that it converts the predetermined transverse mode into the diffracted transvers mode which is incident on the PR at a 90° angle. When part of the diffracted beam is reflected back into the cavity, the HPM converts the diffracted transverse mode back to the predetermined transverse mode. Thus, the resonator of this aspect has a single output and its cavity is divided into regions supporting respective predetermined and diffracted transverse modes and separated from one another by the HPM. In other words, in contrast to the previous aspect, the laser of this aspect is configured to have different transverse modes which travel in the same cavity.

A further feature includes different configurations of the laser components. In particular, the HPM and PR mirror can be configured as two spaced apart components which is similar to the structural features of the previous aspect. Alternatively, the HPM and PR mirror can be configured as a one-body or monolithic component.

Still another feature relates a monolithic laser provided with the HPM. Structurally, the resonator of this aspect is configured with a slab of PTR glass which is doped with any of rare earth ions. Thus, contrast to the structural features of respective previous aspects where the gain medium is just one of the individual intracavity components, the entire slab is the gain medium representing a portable, monolithic solid-state laser. Two HR coatings are deposited on respective opposite sides of the gain element to define a resonant cavity therebetween.

Similarly to one of the previously disclosed features, the monolithic laser of the above-disclosed configuration has two outputs of the diffracted mode. In accordance with a feature of this aspect, the gain element includes an additional HR coating deposited on a side of the element which lies in the path of one of the output diffracted modes providing this structure with a single output.

Still another feature of the current disclosure includes several VBGs that are recorded in the same volume of photosensitive glass where the VBGs with respective HPMs are physically spatially overlap one another while being optically independent. Launching beams with different wavelengths at different incident angles provides diffraction by different PHMs. Structurally, this aspect include the tiltable glass which allows switching among different HPMs and, therefore, differently shaped output transverse modes.

### BRIEF DESCRIPTION OF THE DRAWINGS

The above and other structurally and conceptually complementary features will become more apparent with reference to the accompanying figures, which are not drawn to scale. The figures provide an illustration and a further understanding of the various intertwined aspects and schematics, and constitute a part of this specification, but do not represent the limits of any particular schematic or aspect. In the drawings, each identical or nearly identical component that appears in various figures is denoted by a like numeral.

For purposes of clarity, not every component may have the same reference numeral. In the figures:

FIG. 1 is the optical layout for recording HPMs which operate in accordance with the inventive concept of the disclosure.

FIGS. 2A and 2B are respective diagrammatic views of an exemplary optical schematic providing the measurement and optical beam conversion from Gaussian TEM₀₀ to TEM₁₁ mode.

FIG. 3 is one exemplary optical schematic of the inventive broadband laser configured with the HPM intracavity mode converter operating as a bidirectional output coupler.

FIG. 4 is another exemplary schematic of the inventive broadband laser with the HPM intracavity mode converter operating as a single output coupler.

FIG. 5 is still another optical schematic of the inventive broadband laser provided with the HPM mode converter.

FIG. 6 is the inventive laser provided with the HPM intracavity mode converter and configured as a monolithic optical generator.

FIG. 7 is an optical schematic of the operating prototype of the inventive broadband laser of FIG. 3.

FIG. 8A is a diagrammatic schematic of capturing the broadband laser output beam diffracted in accordance with the optical schematic of FIG. 7.

FIG. 8B₁-8B₃ illustrate respective different spatial modes of the laser output which is captured in the far field of the transverse mode diffracted in accordance with the schematic of FIG. 8A.

FIG. 9 is an optical schematic of the operating prototype of the inventive broadband laser of FIG. 5.

FIG. 10A is a diagrammatic schematic of capturing the broadband laser output beam diffracted in accordance with the optical schematics of respective FIG. 9.

FIG. 10B₁-10B₃ illustrate different respective spatial modes of the broadband laser output captured in accordance with the schematic of FIG. 10A.

FIG. 11 illustrates the operation of a multiplexed HPM carrying out the inventive concept according to FIGS. 3, 4 and 5.

### SPECIFIC DESCRIPTION

The disclosure teaches a laser having a resonant cavity geometry which conditions the predetermined intracavity transverse mode, and a HPM mounted in the cavity to diffract a portion of the predetermined mode while embedding the desired phase profile on the diffracted mode which has a spectral width of up to that of the PHM.

It is important to note that a VBG is the simplest volume hologram that can diffract different wavelengths without distorting the initial beam profile as long as they satisfy the Bragg condition. In contrast to the VBG, a HPM changes the incident beam wavefront. Also, this leads to the fact that HPM can be tested with wavelength different or the same as the recording one.

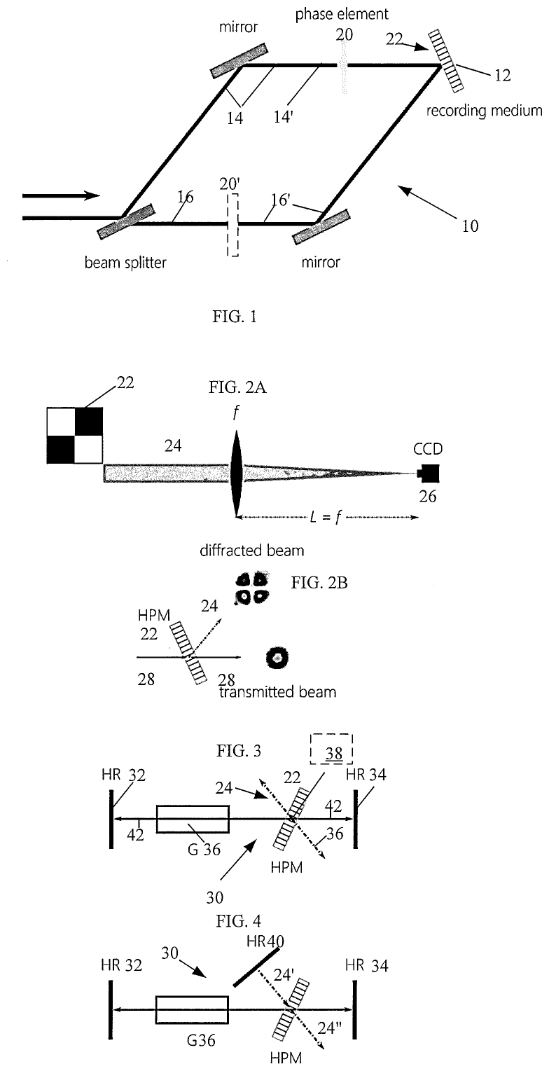

Referring to FIGS. 1 and 2A-2B, the encoding of the desired phase profile into a transmitting Bragg grating (TBG) 12 is carried out by a holographic two-beam recording system 10 including a standard binary phase mask (PM) 20, which is mounted to one of the arms, i.e., chromatic UV beam 14. The PM 20 has the desired phase profile for the hologram wavelength of recording beam 14′ and not for the reconstructing wavelength. The recording beam 14′, which is shaped by PM 20 and does not have any more the Gaussian shape of beam 14, and UV chromatic beam 16, which is split from beam 14 by a beam splitter—interfere at an angle relative to the normal of TBG 12 to create a fringe pattern therein. The HPM 22 fabricated by system 10 has a binary phase profile. Based on the above, when HPM 22 of FIG. 2B is in use, the phase profile of diffracted beam 24, propagating at any wavelength that corresponds to the Bragg condition and measured in fractions of a wavelength by a CCD 26 of FIG. 2A, is the same as that for UV beam 14′.

In particular, FIGS. 2A and 2B illustrate the exemplary beam conversion from Gaussian TEM₀₀ to Gaussian TEM₁₁ mode. The four-sector HPM 22 is encoded in TBG 12 of FIG. 1. The spatial profiles of both diffracted and transmitted beams 24 and 28 of FIG. 2B are recorded in the far field via a Fourier lens. The spectral width of the diffracted beam may be as broad as the spectral width of HPM 22. The latter may be up to 300 nm or greater which allows beams with a range between a narrow linewidth of up to 1 nm and broad spectral line of up to the width of HPM 22 to be shaped in accordance with the inventive concept.

Returning to FIG. 1, HPM 22 is not limited to the conversion of incident beams having a Gaussian mode. As a beam shaping element, HPM 22 can be fabricated to convert any complex mode to a different complex mode. The recording schematic of FIG. 1 can be used to fabricate HPM 22 operating with complex modes by incorporating an addition PM 20′ with a phase profile different from that of PM 20 and Gaussian beam 16. The interference between complex diffracted transverse recording modes 14′ and 16′ results in HPM 22 which thus has two complex modes recorded in its volume.

Referring to FIGS. 3, HPM 22 mounted in a resonant cavity 30 of the inventive laser operates as an output coupler. A plane resonator is shown here for simplicity. Actually, different types of resonators could be considered for the inventive laser. In addition to gain element G36, resonator 30 is configured with two high reflectance plane mirrors (HR) 32 and 34, respectively. Such a resonator provides a single transverse mode if Fresnel number (F) is less than unit:

$$F = \frac{{r}^{2}}{L λ} ,$$

where r—radius of a fundamental mode, L—resonator length, and λ-wavelength. This mode has a Gaussian lateral profile of intensity. The HR mirrors 32, 34 respectively keep all the generated power inside of resonator 30. Placing HPM 22, which is tuned to the desired Bragg angle, in resonator 30 results in diffraction of predetermined generated intracavity modes 42 in opposite direction within the diffraction plane 35. As a consequence, HPM 22 functions as a bi-directional output coupler. The second output is a result of back-reflection of the predetermined intracavity transverse mode 42 from HR 34 which, when incident on HPM 22, diffracts in the same diffraction plane 36 as initially diffracted transverse mode, but in the opposite direction. The efficiency of coupling could be changed by varying diffraction efficiency of HPM 22 or by gradual detuning of the HPM from Bragg angle which can be accomplished by rotating HPM 22 about its axis by any suitable actuator 38. The efficiency of HPM 22 is selected to meet the requirements specified by the customer. In configurations of FIG. 3 (and FIG. 4) the mask's efficiency does not have to be very high and may be limited to a 20-30% range. The predetermined intracavity transvers mode 42 may be, for example, TMoo, whereas the desired mode may be a high order transverse mode TMmn. Placing HPM 22 in resonator 30 results in the phase incursion in diffracted beams 24. This means that while intracavity predetermined modes between HR mirrors 32, 34, for example, are Gaussian, the two output transverse mode 24 have identical profiles determined by HPM 22 and different from the Gaussian mode. The HPMs can provide almost arbitrary wave fronts for both mode conversion and aberrations correction.

FIG. 4 illustrates the same configuration as FIG. 3 with one additional structural feature. In particular, laser 50 of this figured remedies a drawback of FIG. 3 which is bidirectional output emission leading to a possible 50% power loss of output diffracted mode which is incident on the target to be laser treated. Structurally, resonator 30 is provided with an additional HR mirror 40 aligned with HPM 22 in the diffraction plane which reflects upward diffracted mode (relative to the paper plane) 24′ back into the cavity. The reflected transvers mode 24′ travels through HPM 22 and has the same phase profile as “downward” diffracted mode 24″.

The diffracted beams 24′ and 24″ respectively may have different phase retardation and, therefore, constructively or destructively interfere with one another on a way out of resonant cavity 30. To prevent the distractive interference or simply control it so as to optimize the output power, HR 40 and cavity 30 are displaced relative one another in the diffraction plane by, for example, actuator 38 shown in FIG. 3. Since back-reflected predetermined transverse beam 24′ has the phase profile of HPM 22. All output diffracted modes 24 are further referred to as having the complex phase profile or simply complex modes.

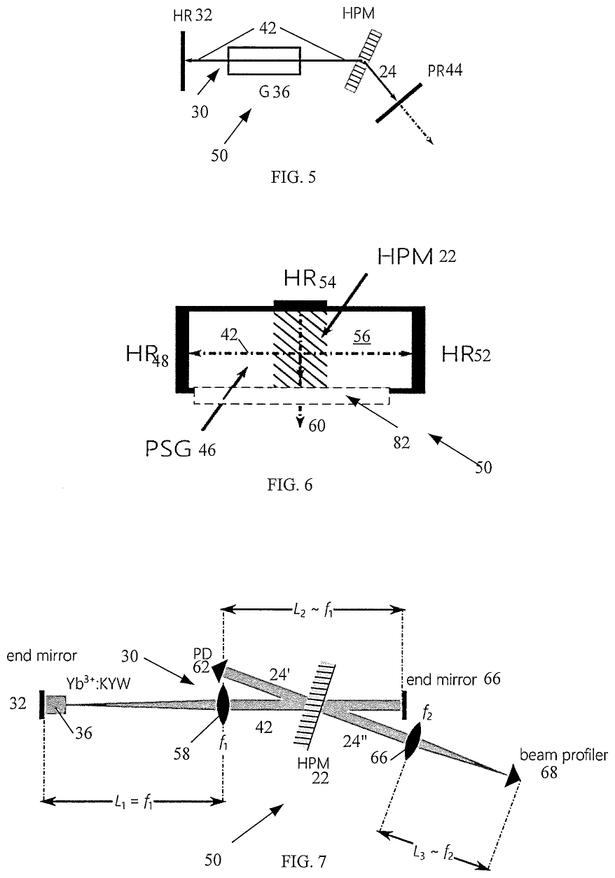

FIG. 5 illustrates a schematic carrying another functional aspect of the inventive concept. Here HPM 22 is not configured as the output coupler but only as the intracavity mode converter mounted in cavity 30. Similar to the configuration shown in respective FIGS. 3 and 4, HPM 22 has the desired efficiency varying in a wide range that allows the mask to meet the requirements of any given specification. In contrast to the previously disclosed configuration, the efficiency of HPM 22 utilized in the configuration of FIG. 5 is preferably above 90%. A further distinction of the schematic of FIG. 5 from that of FIGS. 3 and 4 is that output mirror 44 here is a partially reflected mirror (PR) with the desired coefficient of reflection, and not as a HR mirror of FIG. 3.

The HPM 22 is mounted in such a manner that diffracted beam 24 with the desired phase profile is launched to output coupler PR44 at a normal incident angle. Similar to the previous configurations, predetermined transverse mode 42 would be generated with the aid of gain element G36. If a Fresnel number is less than unit, then predetermined mode 42 is Gaussian. The predetermined transverse mode 42 is converted into the complex phase profile of desired transverse mode 24 by HPM 22. Therefore, two different transverse modes coexist in this resonator—predetermined one 42 to the left from HPM 22 and desired one 24 to the right from the HPM.

FIG. 6 illustrates the inventive laser with an alternative configuration including a photosensitive gain medium PSG46 such as a PTR glass as a one-piece resonator. The PSG46 is is doped with rare earth ions and possesses both high photosensitivity and high quantum yield of luminescence. The use of PTR enables the following design where inventive monolithic solid-state laser 50 emits radiation with almost arbitrary phase profiles. To meet the efficiency requirements HPM 22 is recorded in PSG46 at the predetermined angle varying within a wide angular range. In the shown example, HPM 22 is recorded at 45°.

Three high reflecting coatings HR include two end HRs 48, 52, deposited on respective opposite sides of gain element 46 and defining a resonant cavity 56 therebetween, and third HR 54 which is coated on another of PSG46 sides in the diffraction plane next to the HPM 22. The predetermined mode 42, generated in resonator 56 between end HRs 48 and 52, is partially diffracted while propagating back and forth through HPM 22 as desired transverse modes 60 and 60′ having the same phase profile which is embedded by HPM 22. The HPM 22 thus functions at a bi-directional output coupler. To prevent unnecessary two outputs of desired transverse mode 60, the upwardly diffracted desired mode is reflected back by HR 54 in a manner similar to that of FIG. 4. Then desired mode 60′ is partially diffracted in the propagation plane of predetermined modes 42 while being converted back into predetermined mode 42. The transmitted diffracted mode 60′ interferes with downwardly diffracted mode 60. The difference in phase incursion for the diffracted modes can be tuned by varying the distance between the axis of predetermined mode 42 and upper mirror HR 54. The realization of the phase incursion difference compensation is achieved by either placing laser 50 on multi-axis stage 82 or displacing a pump (not shown) outputting a pump beam which is coupled into the resonator. The laser 50 shown in FIG. 6 is compact and highly resistant to various environmental stresses.

FIG. 7 illustrates an experimental device based on inventive laser 50 of FIG. 3. In particular, a birefringent, single crystal Yb³⁺:KYW is employed as active (doped) gain medium 36 cut along its Nₚ axis with a thickness of 3 mm at the dopant concentration of 2%. The crystal's known broad emission linewidth with its maximum in vicinity of 1040 nm enables the wavelength tunability of laser 50. The gain medium 36 is optically pumped by a fiber-coupled continuous wave (CW) laser diode (not shown) outputting up to 40 W average power at a 981 nm. A set of two aspheric lenses, arranged in a 4f detection configuration and used to image the diode output into a spot size of approximately 250 μm located within gain medium 36. A dichroic end mirror 32, optimized for the incident angle of 0°, is placed between the pump and gain medium 36 with the latter being placed next to mirror 32. The latter has a high transmission efficiency at the 981 nm wavelength and high reflection at 1040 nm wavelength.

The aspherical lens 58 with focal distance f₁=100 mm is inserted one focal length L₁ away from the end facet of the Yb³⁺:KYW gain medium 36, whereas other aspheric lens 66 is configured with a focal length of 250 mm corresponding to length L₃. The lens 58 collimates the predetermined transverse modes 42 generated by gain element 36 and incident on HPM 22 which is mounted into the light path of predetermined modes 42 and angularly tuned to meet its Bragg condition. The predetermined transverse mode 42 transmitted through HPM 22 is launched to a high reflection mirror 32 that forms cavity 30 with HR mirror 34. The desired modes 24′, 24″ are diffracted by HPM 22 form the laser outputs with desired mode 24″ focused on a beam profiler 68 by lens 66 and desired mode 24′ measured by a spectrometer or phot diode 62. The reason for having two desired mode outputs 24′ and 24″ for each cavity roundtrip is the same as that explained above in regard to FIG. 3. The percentage of output-coupled energy is determined by the diffraction efficiency of HPM 22. For an HPM with 5% diffraction efficiency at the lasing wavelength, the roundtrip output-coupling loss is 9.75% (1−0.9²).

Since the HPM's Bragg condition is satisfied, diffracted beams are encoded with the phase profile of HPM 22. The output beams 24″ are subsequently transformed into the desired spatial distribution at the target to be illuminated in the far field, which can be facilitated by sending these beams through Fourier lens 66 (f=250 mm) in a 2f configuration, and observing the beam profile on a CCD camera at the lens' focal distance (L˜f=250 mm). It should be emphasized that both diffracted beams undergo the same phase profile. Thus, this laser has a resonator confined by two high reflecting mirrors while an HPM plays a role of a mode converting output coupler. Efficiency of output coupling could be controlled by diffraction efficiency of the HPM and its detuning from Bragg condition.

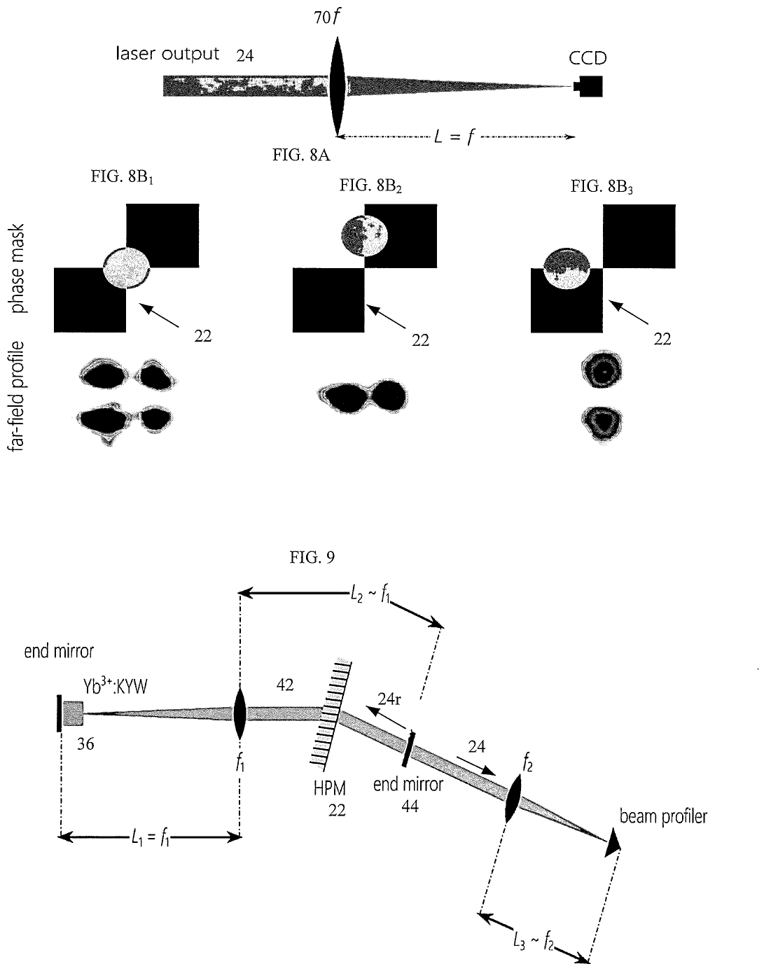

Referring to FIGS. 8A and 8B₁-8B₃, HPM 22 encodes the information of the four-sector phase mask upon insertion thereof into a laser cavity, where it is employed as a two-directional output coupler of FIG. 3. The laser output—desired modes 24—is imaged by a Fourier lens 70 onto a CCD camera, which is spaced from lens 70 at a distance L equal to focal length f, to capture its far-field spatial distribution. The different far-field spatial profiles of respective FIGS. 8B₁-8B₃ are recorded depending upon the position of the HPM which is displaceable relative to the predetermined intracavity lasing beam by actuator 38 of FIG. 3.

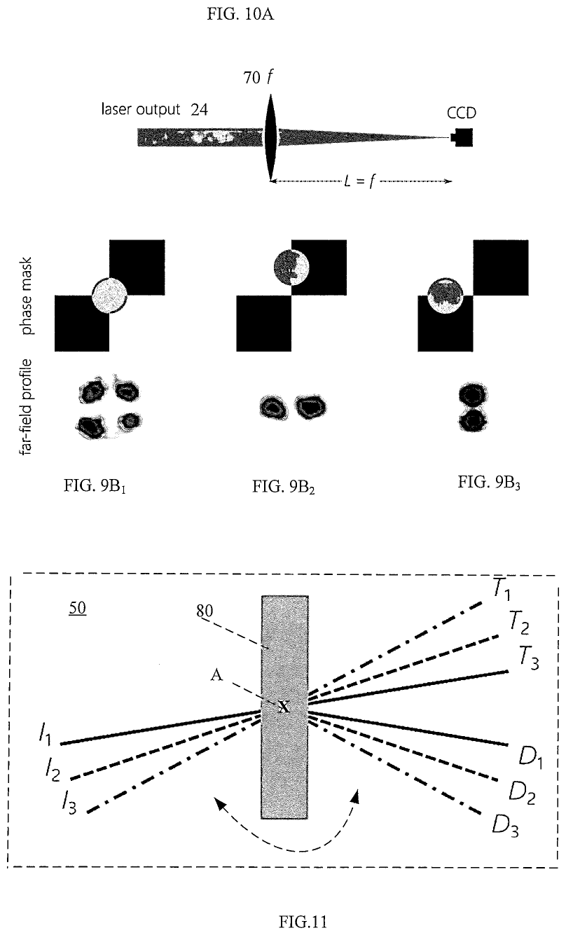

FIG. 9 illustrates the optical layout of another experimental laser 50 based on the configuration of FIG. 5. The main difference between this device and that of FIG. 7 lays in the properties and the role of HPM 22. While in the laser of FIG. 7 the diffraction efficiency of HPM 22 could be rather low to provide the optimal output coupling, HPM 22 here is configured to be highly efficient. Therefore, the intensity of a transmitted beam is very low and the main fraction of radiation is diffracted by HPM 22. The diffracted beam 24 is launched to retro-reflector or PR end mirror 44 which functions as an output coupler. The reflected fraction 24r of the diffracted beam is returned to HPM 22, converted into predetermined mode 42 and directed back to gain medium 36. The important feature of this resonator is that while predetermined mode 42 propagates to the left side from HPM 22, while desired modes 24 with the phase profiled of HPM 22 propagate to the right from the HPM. Thus, HPM 22 functions as an intracavity mode convertor.

Referring to FIGS. 10A and 10B₁-10B₃, sample HPM 22 encoding the information of a four-sector phase mask is inserted into a laser cavity, where it is employed as an intracavity mode convertor. The laser output—desired mode 24 of FIGS. 5 and 9, is imaged by Fourier lens 70 onto a CCD camera to capture its far-field spatial distribution. Different far-field spatial profiles are recorded depending upon the position of the HPM relative to the predetermined mode as shown in 10B₁-10B₃.

Referring to FIG. 11, one the important features of VBGs in PTR glass is the possibility to record several VBGs in the same PTR volume. Several VBGs are physically overlapped in the space but optically independent. Launching beams with respective different wavelengths at different incident angles provides diffraction by different VBGs. This concept was tested by placing a multiplex HPM 80 in inventive laser 50 of the previously disclosed configurations of FIGS. 3, 4 and 5. The multiplex HPM 80 is thus configured in a single PTR volume hosting multiple HPMs recorded therein and having respective phase profiles which are different from one another. The laser 50 with multiplex HPM 80 has been tested and proved that the efficiency of the phase profile of each specific desired mode embedded by a corresponding HPM, which is part of multiplexed HPM 80, is the same as if the individual HPMs were used. Tilting or rotating multiplex HPM 80 about its axis A by any conventional actuator allows laser 50 to switch its output among the recorded desired modes.

The aspects disclosed herein in accordance with the present invention, are not limited in their application to the details of construction and the arrangement of components set forth in the following description or illustrated in the accompanying drawings. Clearly, if broadband modes with up to 300-400 nm linewidth can be successfully shaped in the disclosed configuration, so can be narrowband modes with as small a linewidth as 0.02 nm. These aspects are capable of assuming other embodiments and of being practiced or of being carried out in various ways. For example, the disclosed HPM can be used to compensate a thermal lens formed within the resonator by high-power broadband beams associated with, for example, ultrashort pulse lasers and high power CW lasers that have broadband emission spectra. In another commercial application, this invention will be used to produce near-diffraction-limited high-power laser beams with wide spectra when the phase conversion is performed between different Gaussian-like modes.

Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. References in the singular or plural form are not intended to limit the presently disclosed systems or methods, their components, acts, or elements. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, one of ordinary skill in the art readily appreciates that various alterations, modifications, and improvements will readily occur to those skilled in the art. Accordingly, the foregoing description and drawings are by way of example only.

1. A laser comprising:
a resonant cavity configured to generate radiation in a predetermined transverse mode which oscillates in a propagation plane; and
a broadband holographic phase mask (HPM) mounted in the resonant cavity and fabricated with a phase profile which is different from that of the predetermined transverse mode, the HPM being tuned to a Bragg angle so as to diffract a portion of the generated radiation which has a spectral width of up to a bandwidth of the HPM and propagates in a desired transverse mode with the phase profile of the HPM in a diffraction plane extending transversely to the propagation plane.

2. The laser of claim 1, wherein the resonator cavity is further configured with
a plurality of spaced reflectors delimiting the resonant cavity, at least one reflector being a high reflectivity (HR) mirror, and
a gain element spaced inwards from the reflectors.

3. The laser of claim 2, wherein the spaced reflectors include two HR mirrors flanking the HPM, which operates as an output coupler diffracting the desired transverse mode which propagates in the diffraction plane outside the resonant cavity.

4. The laser of claim 3, wherein the diffracted radiation in the desired transverse mode is output from the resonant cavity in the diffraction plane in opposite directions each depending on a direction of the propagation of the predetermined transverse mode in the propagation plane between the two HR mirrors.

5. The laser of claim 4 further comprising an additional HR mirror which is spaced from the HPM in the diffracted plane and mounted to reflect the output transverse mode propagating in one of the opposite directions in the diffraction plane so that both diffracted transverse modes are decoupled from the resonant cavity in a direction which is opposite to the one direction.

6. The laser of claim 5, wherein the additional HR mirror is displaceable in the diffraction plane to control difference in phase incursion for output desired transverse modes so that the desired transverse modes interfere with one another constructively while being decoupled from the resonant cavity in the opposite direction.

7. The laser of claim 3, wherein the HPM has a diffraction efficiency selected to enable an optimal output coupling.

8. The laser of claim 2, wherein one of the spaced reflectors is a partially reflecting (PR) mirror spaced from the HR mirror, the HPM being mounted to diffract the desired transverse mode which is normally incident on the PR mirror configured to reflect one portion of the desired transverse mode into the resonant cavity and decouple a remaining portion thereof from the resonant cavity.

9. The laser of claim 8, wherein the PR mirror is configured with a coefficient of reflection selected to provide the diffracted radiation in the desired transverse mode with a desired power.

10. The laser of claim 8, wherein the PR mirror and HPM are spaced from one another.

11. The laser of claim 8, wherein the PR mirror and HPM are configured as a monolithic element.

12. The laser of claim 2, wherein the HPM is mounted pivotally about an axis, extending perpendicular to the propagation plane of the predetermined transverse mode and to the propagation plane of predetermined mode, to provide controllable output coupling of the desired transverse mode.

13. The laser of claim 2, wherein the HPM has a plurality of sectors, the HPM is controllably displaceable in the diffraction plane so that the predetermined mode is incident on different locations of the HPM which encodes respective phase profiles on the desired transverse modes different from one another.

14. The laser of claim 2, wherein the HPM is configured with a spectral width ranging between 0.02 and 300 nm.

15. The laser of claim 3, wherein the gain element is a volume of PTR glass doped with one or a combination of rare-earth ions, at least two HR reflectors being coated on respective spaced apart locations of a periphery of the PTR glass so as to define therebetween the propagation plane of the predetermined transverse mode, the HPM being recorded inside the gain element, wherein the gain element with the coated HR coatings and the PTR glass is configured as a monolithic laser.

16. The laser of claim 15, where the HPM is configured as a bi-directional output coupler providing output of the desired transverse modes in respective opposite directions in the diffraction plane.

17. The laser of claim 15 further comprising an additional HR coating aligned with the HPM in the diffraction plane and coated on an additional location of the gain element, wherein the additional HR coating restricts an output of the diffracted radiation in the desired transverse mode to a single one of the opposite direction.

18. The laser of claim 17 further comprising a multi-axis stage supporting and displacing the gain element in the diffraction plane at a desired distance to control a difference in phase incursion for the diffracted transverse modes to provide constructive interference therebetween at the single output.

19. The laser of claim 1, wherein a plurality of HPMs are recorded in a single PTR glass and have respective different phase profiles, wherein the PTR glass being mounted in the resonant cavity to rotate about an axis extending perpendicular to both propagation and diffraction planes so as to controllably change the phase profile of the desired output transverse modes.

20. The laser of claim 1, wherein the HPM is configured to compensate for a thermal lens formed in the resonant cavity by the generated radiation.
